(19) United States
(12) Patent Application Publication
(10) Pub. No.: US 2018/0072506 A1
(43) Pub. Date: Mar. 15, 2018

(54) INTERLOCKING FLOATING SLAT FLOOR SYSTEM

(71) Applicant: Super Sliding Slat Floor Systems, LLC, Vancouver, WA (US)

(72) Inventors: LYNN A. STUART, PORTLAND, OR (US); AJAY SHARMA, VANCOUVER, WA (US)

(21) Appl. No.: 15/706,307

(22) Filed: Sep. 15, 2017

Related U.S. Application Data
(60) Provisional application No. 62/395,019, filed on Sep. 15, 2016.

(51) Int. Cl. B65G 25/06

(52) U.S. Cl. CPC B65G 25/065; B65G 67/02

(57) ABSTRACT

A conveyer system mountable to an installation floor defined by a conveyance path has a plurality of stationary subdecks mounted to the installation floor and extending along the conveyance path. A plurality of elongate floor slats extend along the conveyance path, with each elongate floor slats being in interlocked sliding engagement with a respective one of the stationary subdecks. A plurality of floating inner slat side seals extend along the conveyance path, and are disposed between, and in interlocked sliding engagement with adjacent ones of the elongate floor slats. Outer slat side seals extend along the conveyance path and abutting against outermost ones of the plurality of elongate floor slats, with the outer slat slide seal being mounted to a sidewall of the installation floor.

### CROSS-REFERENCE TO RELATED APPLICATIONS

This application relates to and claims the benefit of U.S. Provisional Application No. 62/395,019 filed Sep. 15, 2016 and entitled INTERLOCKING FLOATING SLAT FLOOR SYSTEM, the entirety of the disclosure of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to conveyer systems for moving large and heavy loads, and more particularly, to an interlocking floating slat floor system.

### 2. Related Art

The transportation of large quantities of goods or bulky items typically involve the use of pallets or skids, which is a flat structure to which the items may be secured via straps, shrink-wrap, or other means. The pallets, in turn, may be moved from one position to another, such as between a warehouse and a semi-trailer, with a forklift, a pallet jack, a crane, or other machinery. Alternatively, the movement of large and/or heavy loads over short distances, whether palletized or not, may be achieved with a moving floor conveyer system.

A basic moving floor system is comprised of multiple movable slats that are hydraulically actuated, and may be installed in the cargo holding compartments of transport vehicles. More specifically, tractor-trailers are common installation sites. In such implementations, a hydraulic pump actuated by the transmission of the tractor via a power take off may be connected to the movable slats. The hydraulic pump, along with the hydraulic fluid reservoir and other hydraulic system accessories are installed on the tractor. The hydraulic pump fluid output and return are provided to the trailer via pressure and return hoses.

Palletized cargo may be loaded and unloaded onto transport vehicles without the use of forklifts and the like. Additionally, bulk particulate matter such as grain, soil, shredded paper, wood chips, as well as garbage or waste may be loaded and unloaded onto transport vehicles with cargo holding compartments equipped with moving floor systems.

The slats are arranged side-by-side in parallel, with each slat extending along the conveying surface. Conventional tractor trailers have lengths of 40 feet, 45 feet, 48 feet, and 53 feet. When all of the slats underneath a load are driven in the same forward direction, that load is moved accordingly. Less than all of the slats may then be moved in the reverse direction back to the starting position. The frictional engagement of reversed slats to the load is insufficient to move the same in the reverse direction, and so the load stays in place. In one or more subsequent cycles, the remaining slats are shifted in the reverse direction back to their starting positions. Once all of the slats are returned to the starting position, the sequence repeats with all of the slats moved in the forward direction, thereby moving the load.

These systems are also known as “walking” systems, but are inefficient and requires additional time to move a load because of the repeated starting and stopping of load movement. Compared to continuous systems, in which a majority of slats are moved in the desired direction while simultaneously moving the remaining slats in the reverse direction, walking or non-continuous systems may require as much as double the time to unload. Furthermore, palletized loads can become skewed during movement. Due to the way the slats are actuated, the hydraulic fluid tends to overheat as a consequence of bypassing the end of all strokes before the hydraulic cylinders can be switched. High pump flow rates are also needed to achieve desirable speeds.

In a typical configuration, the slats are divided into groups, with the slats of each group being interconnected by cross-drive members. These cross-drive members, in turn, are rigidly bolted to the hydraulic actuators that are sequenced via mechanical poppet valves. Many installations utilize twenty four slats and three individual actuators, with each actuator moving eight slats. The design of conventional moving floor systems of this type, also referred to as “move-wait-move” systems, produce high shock pressures because of a mechanical bottoming out of the hydraulic cylinders at the end of each stroke. This is understood to result in instantaneous maximum pressure, followed by the lower pressure when actuated in the reverse direction. Additionally, the extended offset between the actuator and the slats, that is, the lever arm force offset defined as the distance between the centerline force of the hydraulic cylinder and the centerline force directly upon the end of the slat, tends to introduce a heaving effect under certain conditions. The efficiency of existing systems ranges between fifty and sixty percent, and require 1200 to 1500 psi to operate even an empty floor.

Conventional moving floor systems thus tend to be noisy and prone to breakage, as evidenced by the significant market for spare parts. The aluminum slats of a conventional moving floor requires critical alignment with the steel subdeck that is welded on to trailer cross members. Hundreds of small bearings may needed throughout the installation. In the event a heavy piece of debris is trapped between the slat and a bearing, the slat may be heavily damaged. The resultant damage may lead to added friction during operation.

Accordingly, there is a need in the art for an improved moving floor system that can convey loads without skewing pallets, require less input horsepower, and have quieter operation. There is also a need in the art for moving floor systems with minimized lever offset forces and that utilized fewer parts, weighs less, and is physically smaller.

### BRIEF SUMMARY

The present disclosure contemplates a moving floor system with floor slats that interlock with subdecks and side seals. The moving floor system may be utilized with various drive units that sequence the movement of the slats to move a pallet or bulk payload along a conveyance path. The system may be installed on various transport vehicles such as trailers, and such installations are anticipated to require less labor hours. In accordance with various embodiments of the moving floor system, quieter operation and longer lifespans are envisioned. One embodiment of the present disclosure is a conveyer system mountable to an installation floor defined by a conveyance path with a predefined length. The moving floor system may include a plurality of stationary subdecks mounted to the installation floor and extending along the conveyance path. Additionally, there may be a plurality of elongate floor slats extending along the conveyance path. Each of the elongate floor slats may be in interlocked sliding engagement with a respective one of the stationary subdecks. The moving floor system may also include a plurality of floating inner slat side seals extending along the conveyance path. The floating inner slat side seals may be disposed between, and in interlocked sliding engagement with adjacent ones of the elongate floor slats. There may also be outer slat side seals extending along the conveyance path and abutting against outermost ones of the plurality of elongate floor slats. The outer slat slide seal may be mounted to a sidewall of the installation floor. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an exemplary embodiment of a moving floor system installed in a trailer;

FIG. 2 is a front cross-sectional view of the moving floor system with a depiction of a rear retainer;

FIG. 3 is a cross-sectional view of a stationary subdeck according to one embodiment of the present disclosure;

FIG. 4 is a cross-sectional view of a floating inner slat side seal according to one embodiment of the present disclosure;

FIG. 5 is a cross-sectional view of an outer slat side seal according to one embodiment of the present disclosure;

FIG. 6 is a perspective view of the moving floor system showing a cross section of the components thereof; and

FIG. 7 is an expanded perspective view of the moving floor system showing an outer slat seal.

### DETAILED DESCRIPTION

The present disclosure encompasses various embodiments of a moving floor conveyer system. The detailed description set forth below in connection with the appended drawings is intended as a description of the several presently contemplated embodiments of the moving floor conveyer system, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second, proximal and distal, and the like are used solely to distinguish one from another entity without necessarily requiring or implying any actual such relationship or order between such entities.

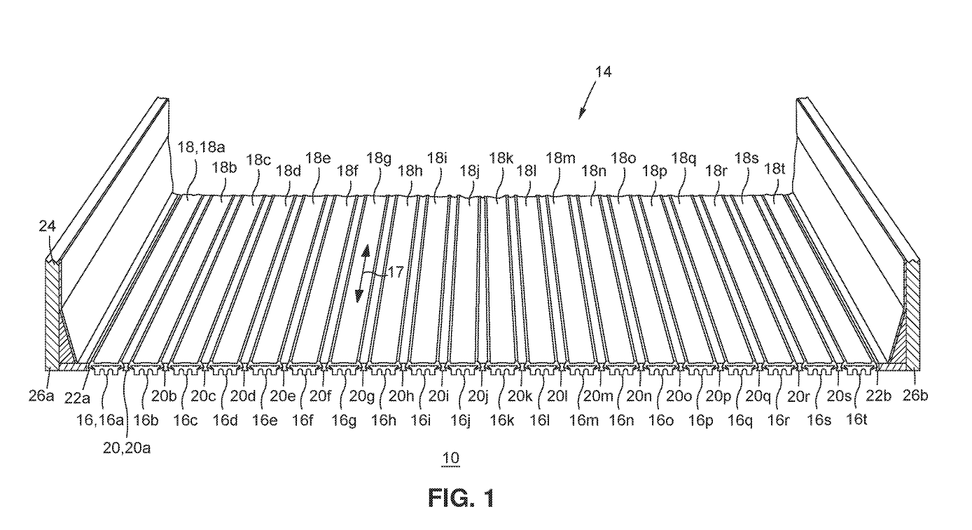

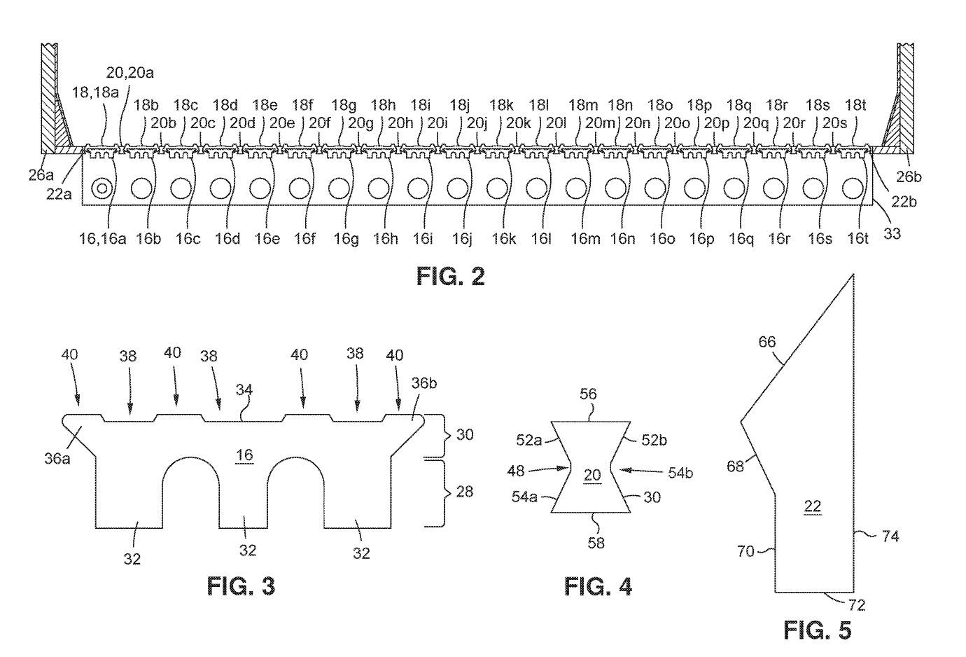

Referring to FIGS. 1 and 2, one exemplary embodiment of a moving floor conveyer system 10 may be installed or mounted to an installation floor. By way of example, the installation floor may be that of a transportation vehicle such as a trailer towed by a tractor. It is expressly contemplated that stationary installations of the moving floor conveyer system 10 in commercial and industrial applications are also possible. For example, in a warehouse, bulk or palletized goods may be conveyed from a storage area to the loading docks via an installation of the moving floor conveyer system 10.

The present disclosure presents the moving floor conveyer system 10 in the context of the tractor-trailer installation, but those having ordinary skill in the art will recognize that the system 10 may be adapted to a variety of different applications. In this regard, reference to features that are specific to the trailer installation is understood to be by way of example only and not of limitation. Such features may be modified for other installations and applications without departing from the scope of the present disclosure.

Generally, the moving floor conveyer system 10 is comprised of an interlocking floor slat assembly 14, along with a hydraulic actuator system that is connected thereto. According to one preferred embodiment, the hydraulic actuator system is a continuous drive system that uses various numbers of hydraulic cylinders. With the majority of the slats being moved in the conveyance direction, a payload placed thereon are moved accordingly along the longitudinal axis of the slats. The interlocking floor slat assembly 14 may be utilized in connection with conventional move-wait-move hydraulic actuator systems, though continuous drive systems are understood to be advantageous with respect to reductions in noise, shock, and avoidance of premature failure in the hydraulic components and the trailer components. Indeed, under proper operating conditions, such moving floor conveyer systems meet or exceed the lifespan of the trailer itself.

Depending on the configuration of the hydraulic actuator system, cross drives may or may not be needed. For example, the conventional three cylinder, move-wait-move system, the actuators are connected underneath the floor slats and requires cross drives that connect groups of separated slats. In a four cylinder, continuous drive system, the actuators may likewise be connected underneath the floor slats, and also utilizes cross drives. The hydraulic actuator system may also be a twenty cylinder, continuous drive system in which the hydraulic actuator is connected to the front of the floor slats, and no cross drives are utilized. One embodiment of a hydraulic actuator system for a moving floor conveyer system is disclosed in U.S. Pat. No. 9,266,682 to Pistacchio et al., the entirety of the disclosure of which is hereby incorporated by reference. A hydraulic actuator system configured in accordance therewith is understood to require no external fluid lines, tubes, or hoses, which eliminates the source of hazardous fluid leaks.

The interlocking floor slat assembly 14 includes a plurality of stationary subdecks 16. More particularly, in the illustrated embodiment, there are twenty stationary subdecks 16a-16t that extend along a conveyance path 17. Each of the stationary subdecks 16 are mounted to the installation floor, e.g., the floor of the trailer. In an interlocked, sliding engagement with the stationary subdecks 16a-16t are corresponding elongate floor slats 18a-18t, respectively. The elongate floor slats 18 likewise extend along the conveyance path 17. Additional structural details of the interlocking relationship between the stationary subdecks 16 and the elongate floor slats 18 will be considered below.

The interlocking floor slat assembly 14 additionally includes a plurality of floating inner slat side seals 20 that are also extending along the conveyance path 17. A given floating inner slat side seal 20 is disposed between, and in interlocked sliding engagement with an adjacent one of the elongate floor slats 18. That is, a first floating inner slat side seal 20a is disposed between and in interlocked sliding engagement with the first elongate floor slat 18a and the second elongate floor slat 18b, a second floating inner slat side seal 20b is disposed between and in interlocked sliding engagement with the second elongate floor slat 18b and the third elongate floor slat 18c, and so forth. Continuing with the installation in the trailer, to the extent twenty elongate floor slats 18a-18t are utilized, there is understood to be nineteen floating inner slat side seals 20a-20s.

The outer portion of the outermost elongate floor slats 18, that is, the first elongate floor slat 18a and the twentieth elongate floor slat 18t also abut against outer slat side seals 22a, 22b, respectively. More particularly, the first elongate floor slat 18a is in sliding engagement with the first outer slat side seal 22b, while the twentieth elongate floor slat 18t is in sliding engagement with the second outer slat side seal 22b. The outer slat side seals 22 also extent along the conveyance path 17. In FIGS. 1 and 2, the interlocking floor slat assembly 14 is shown mounted to a floor width control pan 24 that is defined by a pair of opposed sidewalls 26a, 26b. As shown, the first outer slat side seal 22a is mounted to the left sidewall 26a, while the second outer slat side seal 22b is mounted to the right sidewall 26b.

Again, the foregoing embodiment is understood to be a typical installation for a trailer. To the extent the interlocking floor slat assembly 14 is utilized in other contexts where the width thereof differs, various embodiments contemplate minimum floor widths and maximum floor widths. By way of example, a minimum floor width is one set of four elongate floor slats 18, while the maximum floor width may be some multiple of four elongate floor slats 18.

The contemplated interlocking floor slat assembly 14, that is, the elongate floor slats 18 interlocked with the stationary subdeck 16, together with the floating inner slat side seals 20 and the outer slat side seals 22 in combination define a strong floor with reduced friction during movement. The stationary subdeck 16, as well as the floating inner slat side seals 20 and the outer slat side seals 22 are fabricated from a thermoplastic material, preferably ultra-high molecular weight polyethylene (UHMW-PE), while the elongate floor slats 18 are extruded or otherwise fabricated from aluminum.

There is understood to be minimal friction between the full-length interlocked UHMW-PE stationary subdeck 16 and the aluminum elongate floor slats 18 when the two are in sliding when in sliding engagement with each other. Additionally, the UHMW-PE material is understood to be shock-absorbing. The trailers in which the various embodiments of the interlocking floor slat assembly 14 are installed may be driven through rough ground at a dump site or uneven paved surfaces, and so the aforementioned shock-absorbing characteristics of the UHMW-PE material contribute to the increased lifespan of the entire assembly 14. The stationary subdeck 16 essentially serves as a full-length bearing that also strengths the entire interlocking floor slat assembly 14. The payload compensated floating inner slat side seals 20 is understood to serve as a side bearing for the elongate floor slats 18. As will be appreciated by those having ordinary skill in the art, reduced friction while the elongate floor slats 18 slide along the stationary subdeck 16, increased force can be applied at higher levels of efficiency to move the payload. Additionally, with reduced friction, less heat is generated. This is contemplated to represent a substantial departure over conventional welded steel subdecks.

While the embodiments shown in the present disclosure depict the elongate floor slats 18 and the stationary subdeck 16 as a single extrusion, this is understood to be by way of example and not of limitation. Both of these components may be comprised of multiple sections that are bolted or otherwise coupled together to define a single elongate floor slat 18 or stationary subdeck 16. Shorter extrusions of the stationary subdeck 16 and the elongate floor slats 18 is understood to improve component accuracy, as well as reduced production and replacement costs.

Referring now to the cross-sectional view of FIG. 3, additional details of the stationary subdeck 16 will be considered. As indicated above, the stationary subdeck 16 is an extrusion of UHMW-PE material, and has a generally elongated configuration. The cross-section of the stationary subdeck 16 further illustrates a base portion 28 and a platform 30. The base portion 28 includes a one or more feet 32 that extend downwardly from the platform 30. The feet 32 contact the installation floor, though it is expressly contemplated that it is not necessary to weld, screw, or otherwise attach the feet 32 thereto.

As illustrated in FIG. 2, the stationary subdeck 16 may be anchored to the rear of the trailer, e.g., with a rear retainer 33. This way, thermal expansion and contraction of the trailer, as well as the stationary subdeck 16 may be accommodated. The rear retainer 33 may be constructed of stainless steel, and may be bolted in several places across the width of the trailer rear header. The stationary subdeck 16 may further be secured via machined slots therein and overlapping the rear retainer 33 by the interlocking elongate floor slats 18. It is understood that the rear retainer 33 automatically aligns the stationary subdecks 16, and so no laser alignment or welding is required.

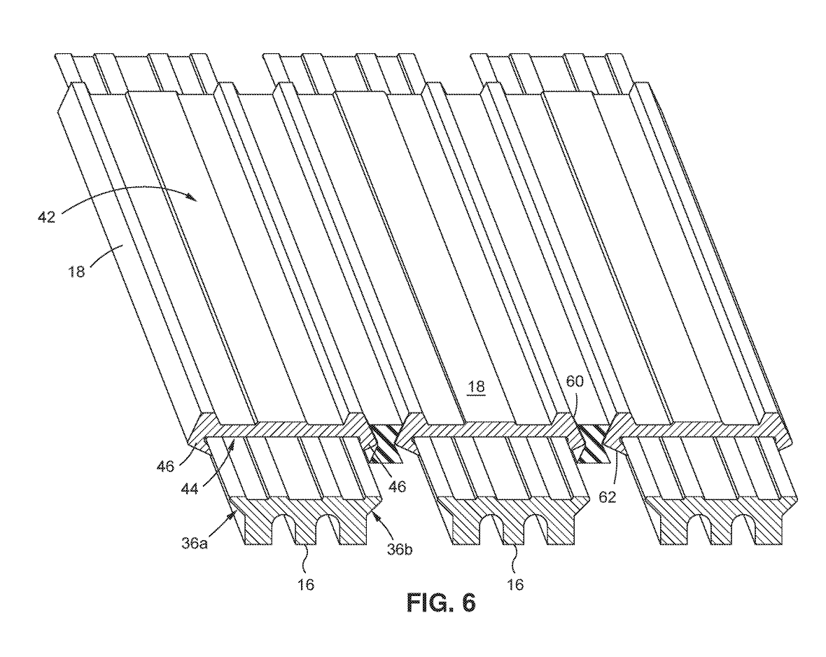

The platform 30 is characterized by a top surface 34 and opposed oblique portions 36a, 36b that serves as tracks that engage with correspondingly keyed slots of the elongate floor slats 18. With additional reference to FIG. 6, the elongate floor slat 18 is defined by a top portion 42 that faces the payload during operation, along with an opposed slot 44. The slot 44 is defined by a pair of opposed lips 46 with an inner configuration that correspond in shape and size to the oblique portions 36a, 36b of the stationary subdeck 16. In this regard, the elongate floor slat 18 cannot be lifted upwards, as it is interlocked with the stationary subdeck 16.

The top surface 34 of the stationary subdeck 16 may define one or more flutings 38 that does not contact the surface of the elongate floor slat 18, along with one or more protuberant segments 40 that do contact the surface of the elongate floor slat 18. Reducing the bearing surfaces between the elongate floor slat 18 and the stationary subdeck 16 is understood to reduce friction, though a completely flat top surface 34 is also contemplated. It will be recognized that the specific shapes that allow for the interlocking sliding engagement of the elongate floor slat 18 and the stationary subdeck 16 is by way of example only and not of limitation, and alternative shapes, sizes, and proportions of one part to another may be substituted.

FIG. 4 is a cross-sectional view of the floating inner slat side seals 20. As shown, the floating inner slat side seal 20 has an hourglass shape that generally, or at least partially corresponds to the outline of the lips 46 of the elongate floor slats 18 Like the stationary subdeck 16, the floating inner slat side seals 20 is extruded UHMW-PE. In further detail, there is left side 48 and an opposed right side 50, with the left side 48 defining a top bevel 52a and a bottom bevel 54a. Moreover, the right side 48 likewise defines a top bevel 52b and a bottom bevel 54b. Connecting the top bevel 52a of the left side 48 to the top bevel 52b of the right side 50 is a top surface 56, while the bottom bevel 54a of the left side 48 to the bottom level 54b of the right side 54 is a bottom surface 58.

As best shown in FIG. 6, the lip 46 of the elongate floor slats 18 is defined by a top wedge segment 60 and a bottom wedge segment 62. According to the illustrated embodiment, the top wedge segment 60 of the elongate floor slat 18 contacts and is in sliding engagement with the floating inner slat side seal 20, though this is exemplary only. Again, the floating inner slat side seals 20 slidably engages the elongate floor slats 18, and further defines a seal that prevents particles on the top portion 42 drops to the area of the stationary subdeck 16. The floating inner slat side seals 20 are payload compensated, and function as a check valve that provides a leak resistance floor system. The floating inner slat side seals 20 may provide side bearing support, and contribute to maintaining the alignment of the elongate floor slats 18.

Also referring to FIG. 4, the apex between the top bevel 52 and the bottom bevel 54 of the floating inner slat side seals 20 generally corresponds in position to the apex between the top wedge segment 60 and the bottom wedge segment 62 of the elongate floor slat 18. In this embodiment, it is expressly contemplated that if the engagement surface of the floating inner slat side seal 20 is damaged, it may be reversed or turned over. Thus, the top and the bottom of the floating inner slat side seal 20 may be symmetrical.

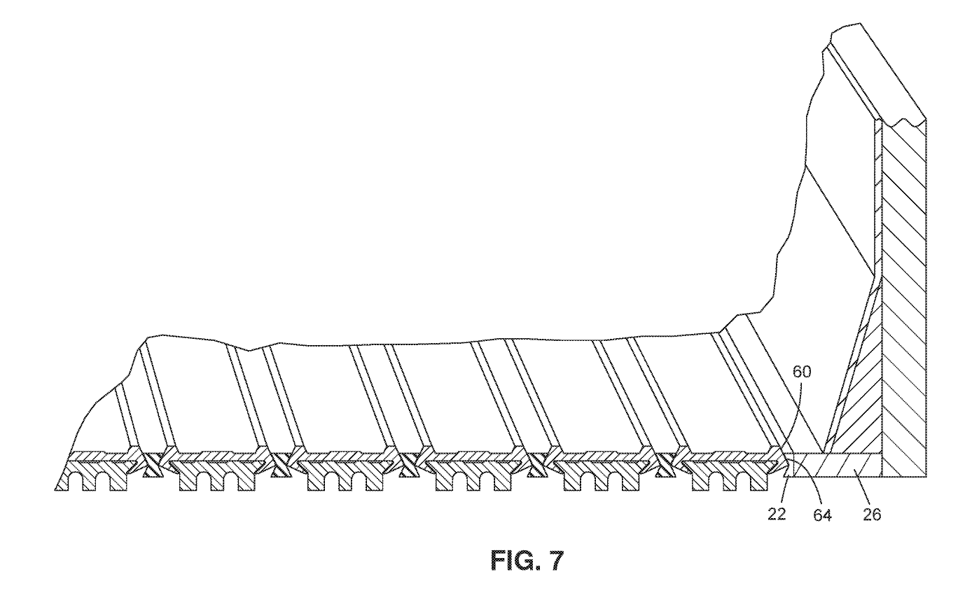

The outer slat side seal 22 is understood to have essentially the same structural and functional features, though because it is to be mounted to the sidewalls 26, either the left half or the right half may instead be a vertical wall. A first embodiment of the outer slat side seal 22 is shown in FIG. 7, with the top wedge segment 60 of the elongate floor slat 18 in sliding engagement with a top bevel 64 of the outer slat side seal 22. An alternative configuration of the outer slat side seal 22 is shown in FIG. 5, which defines a primary bevel 66, an opposite secondary bevel 68, and a short vertical segment 70. There is also a bottom horizontal segment 72, and connecting that and the opposite end of the primary bevel 66 is an extended vertical segment 74 that allows the outer slat side seal 22 to be fixed to the sidewall 26.

Referring again to the FIGS. 1 and 2, the stationary subdecks 16 are assembled into multiple floor width control pans 24 that are spaced approximately five to six feet apart throughout the entire length of the installation floor. The partial floor width control pans 24 may be fabricated with stainless steel, and welded to the cross members on trailers. According to one embodiment, the partial floor width control pans 24 may be installed such that it is level with the top of the cross members, and for the stationary subdecks 16 to lay flat throughout the entire length of the trailer.

As discussed above, a variety of actuator modalities may be utilized in connection with the above-described interlocking floor slat assembly 14. The interlocking configuration of the elongate floor slats 18 allow for the machining of slots in the stationary subdeck 16 to accommodate relatively short connectors to the actuator. Such shortened connections are understood to minimize lever arm force effects between the hydraulic cylinder and the elongate floor slats 18. The slots or cutouts also enable the connection of multiple slats with an aluminum (7000 series) connector rather than a single long slat that is prone to damage during shipment. This connector may also include UHMW-PE cushions that provide a quieter drive system.

Alternatively, the hydraulic cylinders may be in line with each of the elongate floor slats 18, and mounted under a slop sheet disposed at the front of the trailer. This configuration is contemplated to weigh less because cross drive tubes are not needed, nor cross drive locking devices. Maintenance may be simplified and made safer, as hazardous debris can collect underneath the stationary subdeck 16 and recovered during regular maintenance. Furthermore, cost savings may be realized because shorter fluid line installations suffice, as the actuators are located at the front of the trailer. The shorter fluid lines may also reduce hydraulic pressure losses, meaning that more power can be delivered to conveying the payload.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A conveyer system mountable to an installation floor defined by a conveyance path with a predefined length, the moving floor system comprising:
a plurality of stationary subdecks mounted to the installation floor and extending along the conveyance path;
a plurality of elongate floor slats extending along the conveyance path, each of the elongate floor slats being in interlocked sliding engagement with a respective one of the stationary subdecks;
a plurality of floating inner slat side seals extending along the conveyance path and disposed between, and in interlocked sliding engagement with, adjacent ones of the elongate floor slats; and
outer slat side seals extending along the conveyance path and abutting against outermost ones of the plurality of elongate floor slats, the outer slat slide seal being mounted to a sidewall of the installation floor.

2. The conveyer system of claim 1, further comprising:
a rear retainer mounted to a rear end of the installation deck, each of the stationary subdecks being fixed thereto.

3. The conveyer system of claim 1, wherein each of the elongate floor slats is defined by a top portion and an opposed slot.

4. The conveyer system of claim 3, wherein each of the stationary subdecks include a platform interfacing with the slot of a corresponding one of the elongate floor slats.

5. The conveyer system of claim 1, wherein each of the elongate floor slats is defined by a left side wedge and an opposed right side wedge.

6. The conveyer system of claim 5, wherein each of the floating inner slat side seals is defined by a left groove interfacing with the right side wedge of one of the elongate floor slats and a right groove interfacing with the left side wedge of an adjacent one of the elongate floor slats.

7. The conveyer system of claim 1, wherein each of the stationary subdeck extensions include one or more vertical support extensions.

8. The conveyer system of claim 1, wherein the elongate floor slats are defined by one or more separate floor slat segments connected together.

9. The conveyer system of claim 1, wherein the stationary subdecks are constructed of a thermoplastic material.

10. The conveyer system of claim 9, wherein the thermoplastic material is ultra-high molecular weight polyethylene (UHMW-PE).

11. The conveyer system of claim 1, wherein the inner slat side seals and the outer slat side seals are constructed of a thermoplastic material.

12. The conveyer system of claim 11, wherein the thermoplastic material is ultra-high molecular weight polyethylene (UHMW-PE).

13. The conveyer system of claim 1, wherein the elongate floor slats are constructed of aluminum.

14. The conveyer system of claim 1, further comprising one or more hydraulic actuators coupled to groups of one or more of the elongate floor slats.

15. The conveyer system of claim 14, wherein a first group of one or more elongate slat extrusions is driven in a forward direction simultaneously with a different second group of one or more elongate slat extrusions being driven in a reverse direction.

16. The conveyer system of claim 14, wherein all of the elongate slat extrusions are driven in a forward direction simultaneously.
